(19) United States
(12) Patent Application Publication
(10) Pub. No.: US 2016/0264755 A1
(43) Pub. Date: Sep. 15, 2016

(54) ADDITIVE COMPOSITION COMPRISING LUBRICANT

(71) Applicants: DOOBON INC., Chungcheongbuk-do (KR); LOTTE CHEMICAL CORPORATION, Seoul (KR)

(72) Inventors: Dae-Hee LEE, Cheongju-si, Chungcheongbuk-do (KR); Hyun-Duk CHO, Cheongju-si, Chungcheongbuk-do (KR); Young-Guk KIM, Cheongju-si, Chungcheongbuk-do (KR); Dong-Woo LEE, Daejeon (KR); Seung-Moon JEONG, Daejeon (KR); Hyun-Sup LEE, Daejeon (KR)

(21) Appl. No.: 15/033,110

(22) PCT Filed: Nov. 5, 2013
(86) PCT No.: PCT/KR2013/009958

§ 371 Date: Apr. 29, 2016

(51) Int. Cl. C08K 5/103; C08K 5/098

(52) U.S. Cl. CPC C08K 5/103; C08K 5/098

(57) ABSTRACT

The present invention relates to an additive composition comprising a lubricant and, specifically, relates to an additive composition for preparing polyolefin having superior transparency by using a metal lubricant of a specific structure in a sorbitol-based nucleating agent which is an additive used for preparing polyolefin, thereby improving the lubricity of a nucleating agent, lowering a melt temperature, increasing the crystallization rate of polyolefin, and minimizing a shrinkage phenomenon.

### TECHNICAL FIELD

The present invention relates to an additive composition including a lubricant, and, more particularly, to an additive composition for preparation of polyolefin, which includes, in addition to a sorbitol-based nucleating agent which is an additive used in preparation of polyolefin, a metal lubricant of a specific structure to improve lubricity of the nucleating agent, lower melting point, increase crystallization rate of polyolefin, and minimize shrinkage of a resin, thereby improving transparency of polyolefin.

### BACKGROUND ART

Generally, in production and processing of polymers, characteristics such as molecular weight, molecular weight distribution, conformation, composition distribution, stereoregularity, crystal structures, amorphous structures, molecular orientation, phase, and the like are adjusted in order to realize performance and functionality suited to specific applications.

Such characteristics are controllable by varying additives as well as by varying catalysts, polymerization conditions, and polymerization methods, and, among such additives, a nucleating agent serves to control the crystal structure of a polymer. Generally, when a nucleating agent is added to a polymer, various effects, such as improvement in stiffness, transparency and gloss, reduction in molding cycle, and the like can be obtained. For example, a nucleating agent increases the degree of crystallization of a crystalline resin such as polypropylene when the resin is cured from a molten state to a solid state through cooling, whereby the resin can suppressing light scattering and thus exhibit improved transparency and gloss.

Examples of such a nucleating agent for polypropylene include AI-PTBBA and sorbitol nucleating agents. Particularly, sorbitol nucleating agents can provide excellent properties in terms of stiffness and transparency, and are thus widely used.

Such nucleating agents can improve various properties. In this regard, uniform dispersion of a nucleating agent is very important in order to maximize performance thereof. If the nucleating agent is unevenly dispersed, a prepared polymer suffers from significant deterioration in stiffness, transparency and the like, and a preparation process thereof is not efficient.

Particularly, although sorbitol nucleating agents have been actively developed due to excellent effects thereof, the sorbitol nucleating agents exhibit strong adhesion and cohesion and thus can cause a problem during introduction thereof and are also not likely to be uniformly dispersed during mixing after introduction. Further, since the sorbitol nucleating agents increase molding temperature, a resin can suffer from variation in thickness due to shrinkage during injection molding.

Moreover, depending upon molding conditions, the nucleating agents adhere to dies, molds, rolls and the like, possibly causing product failure.

To solve such problems, there has been proposed a method in which oriented polypropylene (OPP) films having excellent transparency are prepared using high melting point polymeric nucleating agents, such as polyvinyl cycloalkane, poly(3-methyl-1-butene), and polyalkenylsilane. However, the high melting point polymeric nucleating agents provide limited performance when used alone in powder form, and thus cannot function well as a substitute for sorbitol nucleating agents.

Moreover, although complexation of a sorbitol nucleating agent with diverse materials has been studied to solve problems of adhesion and cohesion thereof, existing complexed sorbitol nucleating agents have a serious problem in that transparency of prepared polymers is not secured.

Therefore, there is a need for an additive composition which can overcome drawbacks of nucleating agents in terms of adhesion and cohesion while lowering process temperature in preparation of polymers to improve processability and reducing crystallization rate, thereby improving stiffness and transparency of prepared polymers.

### DISCLOSURE

### Technical Problem

It is an aspect of the present invention to provide an additive composition which can overcome drawbacks of a sorbitol nucleating agent, which is an additive used in preparation of a polymer, i.e. problems due to adhesion and cohesion thereof, and improve processability to prevent shrinkage of a resin during injection molding and thus variation in thickness of the resin, and provide enhanced flowability to secure excellent dispersibility, thereby minimizing defects of a prepared polymer while improving transparency and stiffness of a prepared polymer.

### Technical Solution

In accordance with one aspect of the present invention, an additive composition includes: (a) a sorbitol acetal compound; and (b) a metal lubricant.

Here, the (b) metal lubricant is a metal salt in which hydrogen present in a functional group of a C₅ to C₂₅ saturated or unsaturated fatty acid is substituted with Li, Zn, Al, Ca, Mg, Co, Cu, Ti, Na, Zr, K, Ba, Mn or Sn.

### Advantageous Effects

According to the present invention, it is possible to provide an additive composition which can overcome problems due to adhesion and cohesion of a sorbitol nucleating agent by including a metal lubricant and thus can considerably reduce product defect rate and improve transparency and stiffness of prepared polyolefin when used in preparation of polyolefin.

### Best Mode

Details of exemplary embodiments of the present invention are included in the following detailed description.

The above and other aspects, features, and advantages of the present invention will become apparent from the detailed description of the following embodiments. It should be understood that the present invention is not limited to the following embodiments and may be embodied in different ways, and that the embodiments are provided for complete disclosure and thorough understanding of the present invention by those skilled in the art. The scope of the present invention is defined only by the claims.

Hereinafter, an additive composition including a metal lubricant according to the present invention will be described in detail.

In accordance with one aspect of the present invention, an additive composition includes: (a) a sorbitol acetal compound; and (b) a metal lubricant, wherein the (b) metal lubricant is a metal salt in which hydrogen present in a functional group of a C₅ to C₂₅ saturated or unsaturated fatty acid is substituted with Li, Zn, Al, Ca, Mg, Co, Cu, Ti, Na, Zr, K, Ba, Mn or Sn.

The (a) sorbitol acetal compound serves as a nucleating agent and is preferably selected from among 1,3:2,4-bis(p-methylbenzylidene)sorbitol, bis(3,4-dimethylbenzylidene)sorbitol, bis(p-ethylbenzylidene)sorbitol, bis(p-methylbenzylidene sorbitol), dibenzylidene sorbitol, and 1,2,3-trideoxy-4,6:5,7-bis-O-[(4-propylphenyl)methylene]-nonitol. Preferably, the (a) sorbitol acetal compound further includes benzoic acid sodium salt, benzoic acid lithium salt, aluminum benzoate, micronized talc, and organophosphorus salt.

The (b) metal lubricant is mixed or coated onto a surface of the (a) sorbitol acetal compound to reduce adhesion and cohesion of the (a) sorbitol acetal compound, thereby improving flowability and lower processing temperature to improve processability, thereby preventing shrinkage of a resin during injection molding and thus variation in thickness of the resin and enhances transparency of a prepared polymer product while improving dispersibility of the sorbitol acetal compound within a polymer in preparation of polyolefin.

In the present invention, the (b) metal lubricant is a metal salt in which hydrogen present in a functional group of a C₅ to C₂₅ saturated or unsaturated fatty acid is substituted with Li, Zn, Al, Ca, Mg, Co, Cu, Ti, Na, Zr, K, Ba, Mn or Sn. Specifically, the (b) metal lubricant includes magnesium stearate, calcium stearate, zinc stearate, lithium stearate, sodium stearate, aluminum stearate, and the like.

The metal lubricant preferably has a volume average particle diameter (Mv) of less than 20 μm and a D90 value of less than 50 μm, more preferably an Mv of less than 10.0 μm and a D90 value of less than 30.0 μm.

Here, D90 value of less than μm means that 90% (by volume) of metal lubricant fractions included in the additive composition have a diameter of less than 50 μm.

If the D90 value is greater than or equal to 50 μm, there is a problem in that the additive composition exhibits poor dispersibility due to non-uniformity of particles, and suffers from exudation of organic matter (plate-out) due to difference in time that it takes for particles to reach a melting point, causing deterioration in heat resistance of a prepared polymer.

In the present invention, the (b) metal lubricant is preferably present in an amount of 0.01 parts by weight to 30 parts by weight, more preferably 1 part by weight to 5 parts by weight based on 100 parts by weight of the additive composition. If the amount of the metal lubricant is below the above range, the additive composition exhibits poor properties in terms of flowability and dispersibility, whereas, if the amount of the metal lubricant exceeds the above range, a polymer product exhibits poor transparency.

In the present invention, the (b) metal lubricant may be complexed with the (a) sorbitol acetal compound by adding the metal lubricant during a process of preparing the sorbitol acetal compound or by mixing the metal lubricant with the sorbitol acetal compound after preparation of the sorbitol acetal compound. Here, examples of mixing may include simple mixing, pulverization mixing, coating mixing, melt mixing, and the like.

In accordance with another aspect of the present invention, there is provided a polyolefin composition including the additive composition as set forth above.

Since the additive composition including the metal lubricant according to the present invention can improve processability, the polyolefin composition can have high quality and transparency. In accordance with a further aspect of the present invention, there is provided a product manufactured using the polyolefin composition including the additive composition as set forth above. Examples of such a product may include transparent containers, sheets, films, medical products, and stationery products. Since the additive composition including the metal lubricant according to the present invention has excellent flowability and dispersibility, it is possible to lower process temperature, thereby reducing energy consumption while allowing a polyolefin composition having excellent properties to be prepared in consistent quality.

Hereinafter, the present invention will be described in more detail with reference to a preferred example. It should be understood that these examples are not to be construed in any way as limiting the present invention.

### EXAMPLE

1. Preparation of Sorbitol Acetal Compound Complexed with Metal Lubricant (Additive Composition)

A metal lubricant was complexed with a sorbitol acetal compound using a Henschel mixer in amounts as listed in Table 1, thereby preparing additive compositions of Examples. For comparison, sorbitol acetal compounds not including the metal lubricant according to the present invention were prepared as Comparative Examples.

TABLE 1

| | Sorbitol acetal compound | Metal lubricant | Note |
|---|---|---|---|
| Example 1 | Bis(3,4-dimethylbenzylidene)sorbitol: 95 | Magnesium stearate: | |
| | parts by weight | 5 parts by weight | |
| Example 2 | Bis(3,4-dimethylbenzylidene)sorbitol: 95 | Calcium stearate: | |
| | parts by weight | 5 parts by weight | |
| Example 3 | Bis(3,4-dimethylbenzylidene)sorbitol 95 | Zinc stearate: | |
| | parts by weight | 5 parts by weight | |
| Example 4 | Bis(3,4-dimethylbenzylidene)sorbitol: 95 | 12-Magnesium stearate: | |
| | parts by weight | 5 parts by weight | |
| Example 5 | Bis(3,4-dimethylbenzylidene)sorbitol: 95 | Lithium stearate: | |
| | parts by weight | 5 parts by weight | |
| Example 6 | Bis(3,4-dimethylbenzylidene)sorbitol: | Sodium stearate: | |
| | 95 parts by weight | 5 parts by weight | |
| Example 7 | Bis(3,4-dimethylbenzylidene)sorbitol: | Aluminum stearate: | |
| | 95 parts by weight | 5 parts by weight | |
| Comparative | Bis(3,4-dimethylbenzylidene)sorbitol: 100 | — | — |
| Example 1 | parts by weight | | |
| Comparative | Bis(3,4-dimethylbenzylidene)sorbitol: 97 | — | Hydrophobic |
| Example 2 | parts by weight | | SiO₂: 3 parts |
| | | | by weight |

Here, the metal lubricants used in Examples had a volume average particle diameter (Mv) of 10.0 μm and a D90 of 30.0 μm, and the hydrophobic SiO₂ used in Comparative Example had an Mv of 0.5 μm and a D90 of 2.5 μm.

2. Property Evaluation of Sorbitol Acetal Compound Complexed with Metal Lubricant (Additive Composition)

(1) Powder Fluidity

Powder fluidity was recorded as flow characteristics such as impregnated strength, internal friction, wall friction, shear strength, tensile strength, and apparent specific gravity. Powder fluidity was measured according to KS L 1618-4 (2003) (Test methods of properties of fine ceramic granules: Flowability), and apparent specific gravity was measured in accordance with ASTM D1895-96.

(2) Average Particle Size

Laser diffraction analysis, which is a common technique used for measurement of particle size distribution of powders, was carried out. In this method, a sample was dispersed in a liquid and passed through a transparent cell illuminated by a laser beam to detect a laser scattering pattern by a photodiode array, followed by measurement of particle size. Particle size distribution was recorded by calculation using a parameter measured by a laser diffraction analyzer. As used herein, Mv refers to an arithmetic average particle size measured by volume, and D90 refers to a particle size corresponding to 90% of a cumulative volume-based distribution.

(3) Result of Evaluation

Each of the additive compositions of Examples and Comparative Examples was evaluated as to flowability, apparent specific gravity, index of refraction, and average particle size according to the above property measurement methods. Results are shown in Table 2.

TABLE 2

| | | | Average |
|---|---|---|---|
| | | Apparent specific | particle size |
| | Flowability | gravity | (μm) |
| Example 1 | 2.3 | 0.31 | 2.46 |
| Example 2 | 2.4 | 0.32 | 2.43 |
| Example 3 | 2.4 | 0.32 | 2.48 |
| Example 4 | 2.4 | 0.32 | 2.43 |
| Example 5 | 2.2 | 0.30 | 2.43 |
| Example 6 | 2.1 | 0.29 | 2.43 |
| Example 7 | 2.2 | 0.29 | 2.43 |
| Comparative Example 1 | 1.2 | 0.29 | 2.67 |
| Comparative Example 2 | 1.6 | 0.32 | 2.55 |

3. Preparation of Polyolefin Resin Using Additive Composition

Polypropylene random copolymer flakes, each of the additive compositions prepared in Examples and Comparative Examples, a first antioxidant (Irganox 1010), a second antioxidant (Irgafos 168), and an antistatic agent were mixed, followed by formulation of the mixture using an extruder at about 230° C. Then, the formulated resin was molded into a plaque at a melt temperature of about 230° C., thereby preparing samples for property evaluation. Table 3 shows compositions for preparation of the samples.

TABLE 3

| | Sample | Sample | Sample | Sample | Sample | Sample | Sample | Sample | Sample |
|---|---|---|---|---|---|---|---|---|---|
| | 1 | 2 | 3 | 4 | 5 | 6 | 7 | 8 | 9 |
| First | 20 parts | 20 parts | 20 parts | 20 parts | 20 parts | 20 parts | 20 parts | 20 parts | 20 parts |
| antioxidant | by | by | by | by | by | by | by | by | by |
| | weight | weight | weight | weight | weight | weight | weight | weight | weight |
| Second | 20 parts | 20 parts | 10 parts | 10 parts | 10 parts | 10 parts | 10 parts | 10 parts | 10 parts |
| antioxidant | by | by | by | by | by | by | by | by | by |
| | weight | weight | weight | weight | weight | weight | weight | weight | weight |
| Antistatic | 10 parts | 10 parts | 10 parts | 10 parts | 10 parts | 10 parts | 10 parts | 10 parts | 10 parts |
| agent | by | by | by | by | by | by | by | by | by |
| | weight | weight | weight | weight | weight | weight | weight | weight | weight |
| Additive | 50 parts | — | — | — | — | — | — | | |
| composition | by | | | | | | | | |
| of Example 1 | weight | | | | | | | | |
| Additive | — | 50 parts | — | — | — | — | — | | |
| composition | | by | | | | | | | |
| of Example 2 | | weight | | | | | | | |
| Additive | — | — | 50 parts | — | — | — | — | | |
| composition | | | by | | | | | | |
| of Example 3 | | | weight | | | | | | |
| Additive | — | — | — | 50 parts | — | — | — | | |
| composition | | | | by | | | | | |
| of Example 4 | | | | weight | | | | | |
| Additive | — | — | — | — | 50 parts | — | — | | |
| composition | | | | | by | | | | |
| of Example 5 | | | | | weight | | | | |
| Additive | | | | | | 50 parts | — | | |
| composition | | | | | | by | | | |
| of Example 6 | | | | | | weight | | | |
| Additive | | | | | | — | 50 parts | | |
| composition | | | | | | | by | | |
| of Example 7 | | | | | | | weight | | |
| Additive | — | — | — | — | — | — | — | 50 parts | — |
| composition | | | | | | | | by | |
| of | | | | | | | | weight | |
| Comparative | | | | | | | | | |
| Example 1 | | | | | | | | | |
| Additive | — | — | — | — | — | — | — | — | 50 parts |
| composition | | | | | | | | | by |
| of | | | | | | | | | weight |
| Comparative | | | | | | | | | |
| Example 2 | | | | | | | | | |

4. Property Evaluation of Prepared Polyolefin Resin

Properties of the polyolefin resins (Samples 1 to 7) prepared using the additive compositions of Examples and Comparative Examples were evaluated, and results are shown in Tables 4 to 6.

Property evaluation was carried out by the following methods.

(1) Melt-flow index: Melt-flow index was measured under conditions of 230° C./2.16 kg in accordance with ASTM D1238DP.

(2) Flexural modulus: Flexural modulus was measured under conditions of 23° C./50% RH in accordance with ASTM D790.

(3) Izod impact strength: Izod impact strength was measured under conditions of 23° C./50% RH in accordance with ASTM D256.

(4) Crystallization temperature: Crystallization temperature was measured at a heating rate of 10° C./min via differential scanning calorimetry.

(5) Transparency (Haze)

Transparency of injection molded specimens was measured for each thickness (1 mm and 2 mm) at each molding temperature (190° C., 210° C., 230° C., and 250° C.) in accordance with ASTM D1003. Lower haze values indicate superior transparency.

(6) Colorimeter Measurement

Measurement was performed in accordance with KS A 0067 Color specification-CIE Lab and CIE Luv color spaces, and a color value was confirmed by *b of a Lab color space.

TABLE 4

| | Sample | Sample | Sample | Sample | Sample | Sample | Sample | Sample | Sample |
|---|---|---|---|---|---|---|---|---|---|
| | 1 | 2 | 3 | 4 | 5 | 6 | 7 | 8 | 9 |
| Melt-flow index | 14.6.6 | 14.5 | 14.3 | 14.4 | 14.5 | 14.7 | 14.8 | 16.9 | 17.1 |
| (MI) (g/10 min) | | | | | | | | | |
| Flexural modulus | 18,000 | 18,100 | 18,100 | 18,100 | 18.000 | 18,000 | 18,000 | 18,000 | 18,000 |
| (kg/cm2) | | | | | | | | | |
| Izod impact strength | 8.9 | 9.0 | 9.0 | 9.0 | 9.0 | 8.9 | 9.0 | 8.9 | 9.0 |
| (kg.cm/cm) | | | | | | | | | |
| Crystallization | 128.4 | 128.3 | 128.4 | 128.4 | 128.4 | 128.3 | 128.4 | 130.3 | 130.4 |
| temperature (° C.) | | | | | | | | | |
| Colorimeter | 0.54 | 0.63 | 0.56 | 0.58 | 0.69 | 0.68 | 0.67 | 0.66 | 0.56 |
| (*b) | | | | | | | | | |

TABLE 5

| | | Sample | Sample | Sample | Sample | Sample | Sample | Sample | Sample | Sample |
|---|---|---|---|---|---|---|---|---|---|---|
| Unit: % | | 1 | 2 | 3 | 4 | 5 | 6 | 7 | 8 | 9 |
| HAZE (1 mm) | 190° C. | 12.94 | 12.70 | 12.74 | 12.88 | 12.45 | 13.25 | 13.20 | 13.45 | 13.20 |
| | 210° C. | 10.52 | 10.28 | 10.32 | 10.30 | 10.40 | 10.78 | 10.84 | 11.00 | 11.00 |
| | 230° C. | 9.28 | 9.18 | 9.20 | 9.26 | 9.28 | 9.38 | 9.40 | 9.42 | 9.40 |
| | 250° C. | 8.50 | 8.42 | 8.46 | 8.44 | 8.48 | 8.54 | 8.80 | 8.94 | 8.90 |

TABLE 6

| Unit: % | | Sample 1 | Sample 2 | Sample 3 | Sample 4 | Sample 5 | Sample 6 | Sample 7 | Sample 8 | Sample 9 |
|---|---|---|---|---|---|---|---|---|---|---|
| HAZE (2 mm) | 190° C. | 27.34 | 27.20 | 27.26 | 27.28 | 27.46 | 27.42 | 27.52 | 28.22 | 28.32 |
| | 210° C. | 20.34 | 20.32 | 20.36 | 20.36 | 20.36 | 20.34 | 20.46 | 21.34 | 21.46 |
| | 230° C. | 20.16 | 20.06 | 20.14 | 20.14 | 20.20 | 20.22 | 20.32 | 21.32 | 21.32 |
| | 250° C. | 19.80 | 19.72 | 19.70 | 19.74 | 19.75 | 19.90 | 20.00 | 21.00 | 21.00 |

As shown in Table 4, from the results of the property test for the polyolefin resins prepared as described above, it can be seen that, when the additive composition complexed with the metal lubricant according to the invention was used, the polyolefin resin exhibited relatively low melt flow index and crystallization temperature as compared with those of Comparative Examples and was not different than those of Comparative Examples in terms of flexural modulus and Izod impact strength. Here, low melt flow index and crystallization temperature can cause reduction in processing temperature to make extrusion and injection molding feasible, thereby allowing adjustment range to be increased in processing and molding.

In addition, it can be seen that, when the additive composition complexed with the counteragent was used, a yellow color of the polymer product was not predominant due to a low *b value.

Further, it can be seen that, when the additive composition complexed with the counteragent was used, the prepared polyolefin resin exhibited excellent transparency as compared with those of Comparative Examples.

Although some embodiments have been described herein, it should be understood that various modifications, changes, alterations, and equivalent embodiments can be made by those skilled in the art without departing from the spirit and scope of the invention. Therefore, it should be understood that these embodiments are not to be construed in any way as limiting the present invention and the scope of the present invention should be defined by the appended claims and equivalents thereof.

Although some embodiments have been described herein, it should be understood that the present invention is not limited to the following embodiments and may be embodied in different ways, and that all equivalents and substitutes falling within the spirit and scope of the present invention as defined by the appended claims are intended to be encompassed thereby.

1. An additive composition comprising:
(a) a sorbitol acetal compound; and (b) a metal lubricant,
wherein the (b) metal lubricant is a metal salt in which hydrogen present in a functional group of a C₅ to C₂₅ saturated or unsaturated fatty acid is substituted with Li, Zn, Al, Ca, Mg, Co, Cu, Ti, Na, Zr, K, Ba, Mn or Sn.

2. The additive composition according to claim 1, wherein the metal lubricant represented by Formula 1 has a volume average particle diameter of less than 20 μm and a D90 of less than 50 μm.

3. The additive composition according to claim 1, wherein the metal lubricant represented by Formula 1 has a volume average particle diameter of less than 10.0 μm and a D90 of less than 30.0 μm.

4. The additive composition according to claim 1, wherein the metal lubricant is present in an amount of 0.01 parts by weight to 30 parts by weight based on 100 parts by weight of the additive composition.

5. A polyolefin composition comprising the additive composition according to claim 1.

6. Transparent containers, sheets, films, medical products, or stationery products comprising the polyolefin composition according to claim 5.
